(19) United States
(12) Patent Application Publication
(10) Pub. No.: US 2008/0000927 A1
(43) Pub. Date: Jan. 3, 2008

(54) PUMP ACTUATOR TOPPER

(76) Inventor: Richard S. Butler, Lake Worth, FL (US)

Correspondence Address: MCHALE & SLAVIN, P.A., 2855 PGA BLVD, PALM BEACH GARDENS, FL, 33410, US

(21) Appl. No.: 11/427,393

(22) Filed: Jun. 29, 2006

(51) Int. Cl. B05B 11/00; B65D 5/66; B67D 1/07

(52) U.S. Cl. 222/78; 222/113; 222/192

(57) ABSTRACT

The purpose of this invention is to provide unique and interesting ornamental appearance to a standard pump-type fluid dispenser by providing a topper onto the pump actuator. The pump actuator topper can be used as container label or advertising medium to present a trademark, trade-dress, logo, etc. The decorative effect of the pump topper and dispensing container assembly may be further enhanced when used in combination with an illumination base assembly.

### FIELD OF THE INVENTION

This invention relates to a pump actuator topper for attachment onto a pump actuator of a conventional pump-type fluid dispenser to provide a unique ornamental appearance; particularly, to a pump actuator topper having an ornamental appearance which may be used to present a company's trademark, trade-dress, logo, or advertising message; more particularly, the pump actuator topper and dispenser assembly may be further combined with an illuminating base. The base is constructed and arranged to illuminate the dispenser and/or the pump topper to entice or visually stimulate the user.

### BACKGROUND OF THE INVENTION

There is a continuing need to provide more attractive and innovative ways to label or decorate fluid dispensers for enhanced aesthetic appeal. In the past, marketers have used decorative labels attached to the exterior surface of the dispensing container to entice the user to purchase their product. More recently, three-dimensional designs have been incorporated onto the interior of the dispensing container to provide a more striking appearance.

As consumers have become complacent to the usual advertising mediums, such as, television, radio, magazines, etc., marketers are often forced to invent creative techniques designed to effectively reach the consumer with their products or services. Attaching advertising means, such as a trademark or logo, to a product not characteristically associated with such advertisements is an opportunity to standout and reach new customers. Moreover, interesting and visually stimulating advertising designs are frequently recalled by the consumer.

Pump-type dispensers used for delivery of fluid products, such as, liquid hand soaps, therapeutic hand lotions, antimicrobial gels, sprays, soaps, and the like, are seemingly ubiquitous in the healthcare and food service industries. Persons employed in these fields typically wash their hands multiple times a day. As discovered by the present inventors, these dispensing containers present a unique opportunity for promoting products commonly used in these industries; for example, a dispensing container in a doctor's office could be made to include advertising directed to a pharmaceutical drug.

Therefore, there exists a need for a pump actuator topper having a unique and interesting ornamental appearance constructed for attachment onto the pump actuator of a pump-type fluid dispenser. The ornamental appearance may provide indicia such as an advertising message or design, which indicate the contents inside the dispenser. For a condiment dispenser, for instance, the topper may include the appropriate identifying indicia, (e.g., mustard, ketchup, etc.) for quick identification.

Alternatively, the ornamental appearance may be constructed to provide tactically readable for visually impaired persons to identify the contents in the dispenser, (e.g., braille, raised line pictures, diagrams, etc.)

In addition, the pump topper and dispensing container could be used in combination with an automatic base illumination assembly attached thereto which is capable of illuminating the container and/or topper upon downward movement of the actuator (or topper). The assembly base could also include a means to emit sounds that can correspond to the overall “theme” of the dispenser assembly. This provides a dispenser assembly with a unique multi-media effect.

### DESCRIPTION OF THE PRIOR ART

Currently there are numerous commercially available dispensing containers having a design incorporated onto, or within the container itself.

For example, U.S. Pat. No. 6,276,566 to Zaksenberg discloses a dispensing container which is enhanced by the suspension of a three-dimensional design within the container. This is accomplished by a depending member which projects into the interior of the container. This depending member has a three-dimensional design attached thereto or formed as an integral part thereof.

U.S. Pat. No. 5,937,554 to Haugk et al., discloses a container which has a decorative film label inserted within in a transparent or essentially transparent container. The label or decoration is in the form of a monolayer film or a laminate film with the decoration and other materials under a coating or within the laminate layers.

U.S. Pat. No. 5,915,600 to Bitton discloses a pump, spray, or suction-actuated dispenser with a suction tube extending into a container, wherein the suction tube is used to mount a three-dimensional ornamental figure so that it is visible from the outside of the bottle. Unlike the present invention, none of the aforementioned patents disclose a pump actuator topper which attaches to the pump actuator of a fluid dispenser.

U.S. Design Pat. No. 402,891 to McPhilliamy et al., illustrates an ornamental design for a liquid dispenser top. Unlike the present invention, the ornamental design of '891 does not disclose at least one integrally formed means to attach to the pump actuator.

U.S. Pat. No. 5,301,836 to Luu discloses an liquid dispenser for holding liquid therein. The liquid dispenser includes a cover having a three-dimensional shape of an animal head which fits over a liquid extracting device. The dispenser includes a container having a three-dimensional shape of an animal body for dispensing the liquid out of the container. A separate fastener secures the cover to the liquid dispensing mechanism so that depressing the cover downwardly will operate the liquid dispensing mechanism. The '836 patent fails to disclose a cover of unitary molded construction having at least one integrally formed attachment means. The integrally formed components of the present invention simplify the attachment procedure, since no additional hardware or hand tools are needed for fastening the topper to the actuator.

Patent Pub. No. 2005/0213314 to Mochiachvilli et al., Patent Pub. No. 2004/0218402 to Jao, and U.S. Pat. No. 5,301,836 to Luu disclose containers having an illumination system using light sources placed under the outer container. However, all of these references fail to disclose the use of a pump-actuator topper.

### SUMMARY OF THE INVENTION

The purpose of the instant invention is to provide a unique and interesting pump actuator topper constructed and arranged to attach onto an actuator of a conventional pump-type fluid dispenser. The topper comprises a unitary molded construction comprising a proximal actuating surface and a distal attachment surface including at least one integrally formed attachment means to facilitate attachment to the pump actuator.

The actuating surface provides a unique ornamental appearance that may be used to inform the user of the dispensing container's contents. Alternatively, the actuating surface may be used to present an advertisement or other message directed to persons using these dispensers.

The attachment surface of the pump actuator topper may also include a receiving bore constructed and arranged to receive at least a portion of the pump actuator and prevent lateral movement of the topper attached thereto. Once the pump actuator topper is properly disposed on the pump actuator, the user simply presses downward on the actuating surface to dispense the fluid contained therein.

Accordingly, it is an objective of the instant invention to provide a pump actuator topper having an actuating surface used to present indicia, trademarks, trade-dresses, logos, advertisement, or other message.

It is yet another objective of the instant invention to teach a pump actuator topper which is removably attached to the pump actuator, such that the topper may be removed from one dispenser, interchanged, or placed onto another pump-type dispenser.

Another objective of the present invention is to teach a container having at least one design attached thereto that complements the ornamental design of the actuating surface of the pump topper. This results in a dispenser assembly having an overall theme, (e.g., holiday or event).

Still another objective of the instant invention is to teach a container formed into a three-dimensional design that complements the ornamental design of the actuating surface of the pump topper.

Yet another objective of the present invention is to teach a pump actuator topper comprising a single, unitary molded construction. The unitary molding construction provides increased structural integrity without the need of separate attachment components (e.g., fasteners).

Another objective of the instant invention is to provide a pump actuator topper having a three-dimensional design that includes at least one identification means that allows the visually impaired to identify the contents in the dispenser to which it is attached. For example, the topper may include any tactically readable indicia, such as, braille, raised line pictures, diagrams, or the like.

Still another objective of the present invention is to teach an illuminating base assembly for use with any of the various embodiments of the dispenser container and topper assembly. The base assembly illuminates the container, dip tube, actuator, and/or pump topper when downward pressured is applied to the pump actuator for a unique decorative effect.

Another objective of the present invention is to teach an illuminating base assembly that includes a sound emitting means that will also play sounds or music when downward pressured is applied to the pump actuator for an enhanced multimedia effect.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1a is a lower perspective view of one embodiment of pump actuation topper of the present invention illustrating an integrally formed means of attachment;

FIG. 1b is side view of the pump actuation topper of FIG. 1a;

FIG. 1c is a front view of the pump actuation topper of FIG. 1a;

FIG. 1d is a top view of the pump actuation topper of FIG. 1a;

FIG. 2a is a front view of the pump actuation topper of FIG. 1a, illustrated attached to a pump actuator;

FIG. 2b is a side view of the pump actuation topper illustrated in FIG. 1a, shown attached to a dispenser assembly;

FIG. 3a is a lower perspective view of another embodiment of the topper of the present invention illustrating the integrally formed receiving bore and ribs;

FIG. 3b is a front view of the pump actuation topper of FIG. 3a;

FIG. 3c is a side view of the pump actuation topper of FIG. 3a;

FIG. 4a is an upper perspective view of the topper embodiment shown in FIG. 3a attached to the pump actuator;

FIG. 4b is a side view of the embodiment shown in FIG. 3a attached to the pump actuator;

FIG. 5 is a side view of the fluid dispenser assembly with attached topper;

FIG. 6 is a lower perspective view of the fluid dispenser assembly seen along lines 1-1 of FIG. 5;

FIG. 7 thru FIG. 9 illustrate various embodiments of the fluid dispenser assembly comprising various designs, wherein the three-dimensional design of the toppers and the three-dimensional design of the containers coordinate with each other;

FIG. 10 is an exploded perspective view of the illumination base assembly with a holiday theme (i.e., Christmas tree) dispenser and pump topper assembly of the present invention;

FIG. 11 is a perspective view of the fluid dispenser assembly with attached pump topper and illuminating base assembly, illustrating the projection of light from the base through the dip tube and to pump topper for a striking effect.

### DETAILED DESCRIPTION OF THE INVENTION

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

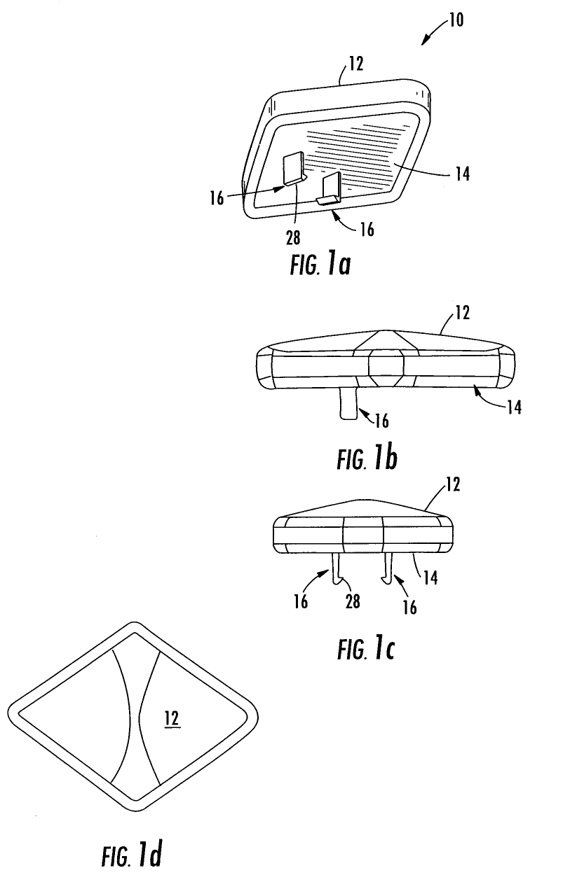

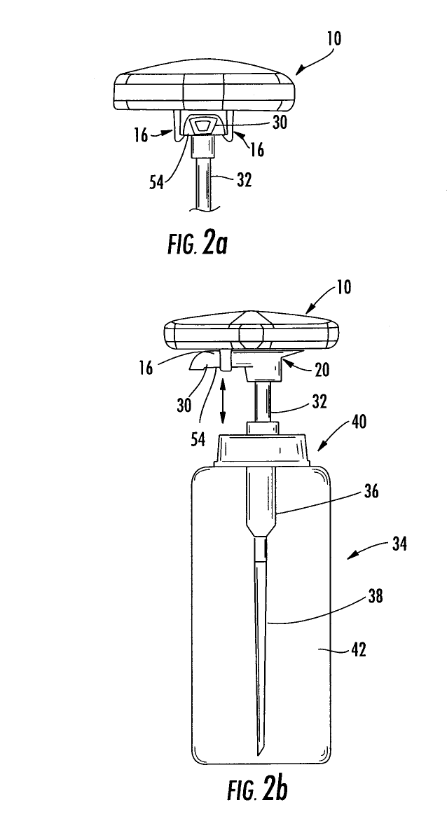

Referring now to FIGS. 1-11, wherein like elements are numbered consistently throughout, FIG. 1 shows a lower perspective view of one embodiment of the instant pump actuator topper, generally referenced as 10.

In the preferred embodiment, the topper is of a single, unitary construction formed from, not limited to, a suitable plastic such as polystyrene or polyethylene through any molding process capable of forming integrally connected components, including, albeit not limited to, injection molding, blow molding, extrusion, etc.

As illustrated in the embodiment of FIGS. 1a-1d, the molded, unitary construction of the topper results in an actuating surface 12, attachment surface 14, and at least one means of attaching, all of which are integrally formed for easy connection onto, and removal from, any standard pump actuator without the need for separate attachments means.

The pump-type dispenser discussed herein is widely obtainable, for example, it may be purchased world-wide from manufactures such as Ningbo Jinyu Spray Co. Ltd (China). For persons acquainted with the art, pump-type fluid dispensers are well known and accepted universally.

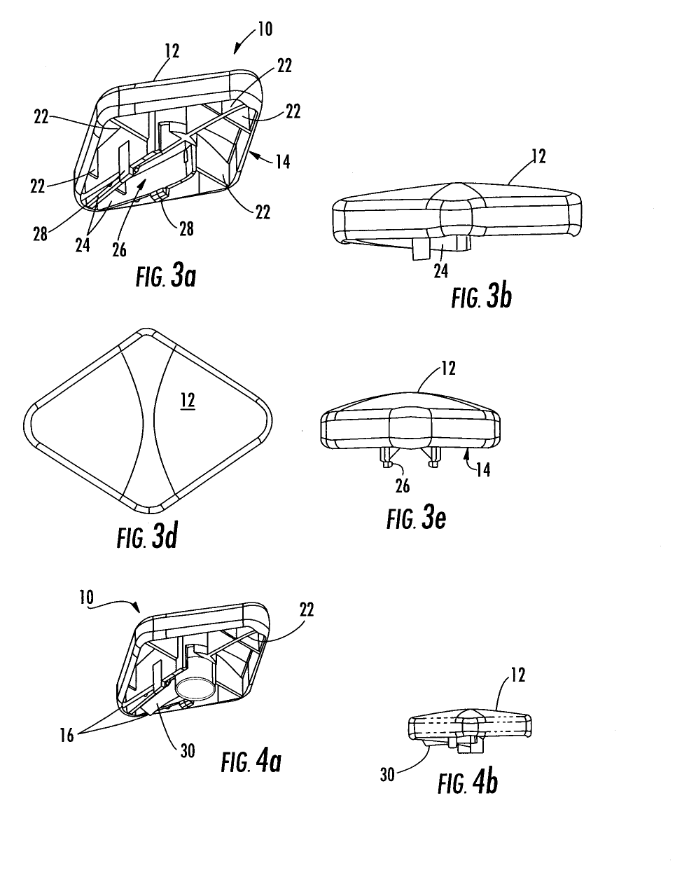

Referring now to FIG. 2b, by way of an overview, the typical pump-type dispenser includes a pump actuator 20 removably attached the upper end 40 of a container 34 having at least one sidewall 42, an upwardly biased piston 32, an accumulator 36 integrally connected to the dip tube 38, which is in fluid communication with the fluid product inside the container.

The downward depression of the actuator by the user moves the piston 32 into the accumulator. Next, the upwardly biased piston moves up, which in turn, creates a vacuum in the accumulator 36, causing the fluid product to flow through the dip tube into the accumulator. Once primed, the pump dispenses the product through the nozzle 30 with each subsequent downward actuation of the pump actuator.

The topper is attached to the pump actuator by a plurality of integrally formed attachment means, shown in FIGS. 1a-2b as two projections 16 in spaced apart relation and disposed substantially perpendicular to the attachment surface 14. Each projection is constructed and arranged to have sufficient flexibility and rigidity to effectively engage the opposite edges of most standard pump actuators and remain attached thereto when the user presses downwardly on the actuating surface (FIGS. 2a and 2b). Each of the projections has a perpendicularly disposed flange 28 formed at the distal ends thereof. The flange projects inwardly toward the other projection so that the flange of each projection snap-fits or otherwise frictionally engages the bottom edge 54 of the pump actuator.

It is hereby contemplated that the attachment means may be permanently attached to the actuator. However, from a versatility standpoint, it is preferred that the projections are formed from a material of sufficient flexibility so as to allow it to be easily replaced or interchanged onto another dispenser assembly. For example, once the contents of a pump-type dispensing container are depleted, the user can remove the topper attached thereto and place it onto a new dispensing container.

Although the attachment means is depicted herein as having two projections, it is also within the purview of the invention to provide a single projection (not shown) constructed and arrange to snap-fit or otherwise engage one edge (i.e., back edge) of the pump actuator.

Referring to now to the embodiment of FIGS. 3a-d and 4a-b, the attachment means comprises a plurality of spaced apart panels 24 integrally formed to the attachment surface. These panels are constructed and arranged to create a generally centralized receiving bore 26 adapted to receive at least a portion of a standard pump actuator 20 and pump actuator nozzle 30. In a preferred embodiment, the lowermost edges of the panels have at least one integrally formed panel flange 28 projecting into the receiving bore. As with the projections 16, the panels should be sufficiently flexible and rigid so that the panel flanges 28 frictionally engage or “snap over” the lowermost edges of the pump actuator. The receiving bore prevents lateral movement of the topper when mounted onto the actuator.

The topper may be formed as solid plastic component having a proximal actuating surface molded into any ornamental design with a distal attachment surface and a plurality of integral attachment means, formed by any of the aforementioned molding processes. However, it is preferred that the topper is made of a substantially hollow light-weight construction, (see FIGS. 3a-d) thereby minimizing the extra material cost and weight associated with solid-form construction.

As illustrated in FIGS. 3a-d, the substantially hollow construction of topper may be reinforced by a plurality of integrally formed cross-bracing ribs 22 formed at the attachment surface to provide the necessary rigidity to the topper while maintaining the actuating surface in a generally smooth condition for aesthetic purposes. The integrally formed ribs increase the structural integrity of the topper by preventing the front, back and side portions from bowing or bending.

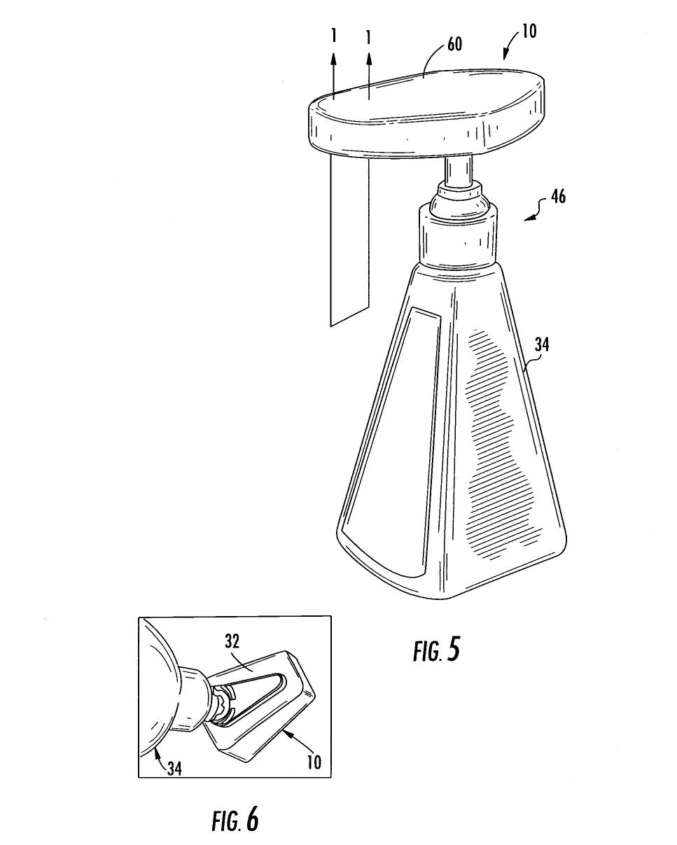

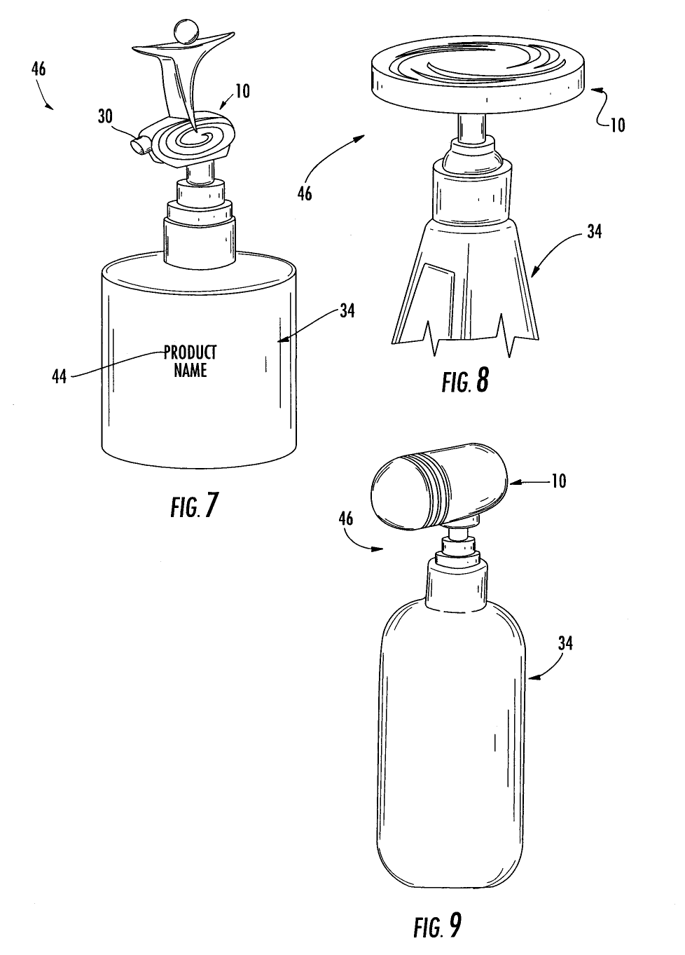

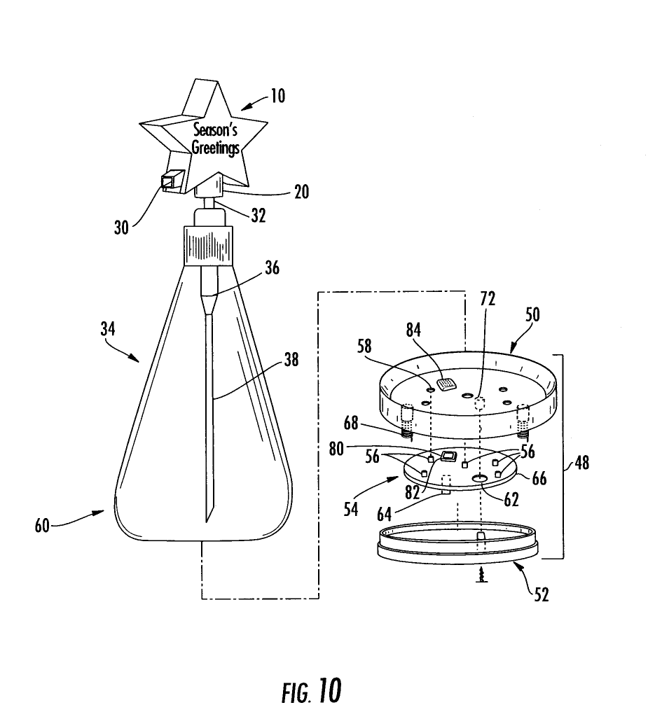

The actuating surface may also include an integrally formed lower covering portion 32 integrally formed with actuating surface and designed to cover the ribs and/or panels to provide the topper with continuous surface for an improved overall aesthetic appearance (FIG. 6) as seen along lines 1-1 of the dispenser assembly 46 of FIG. 5.

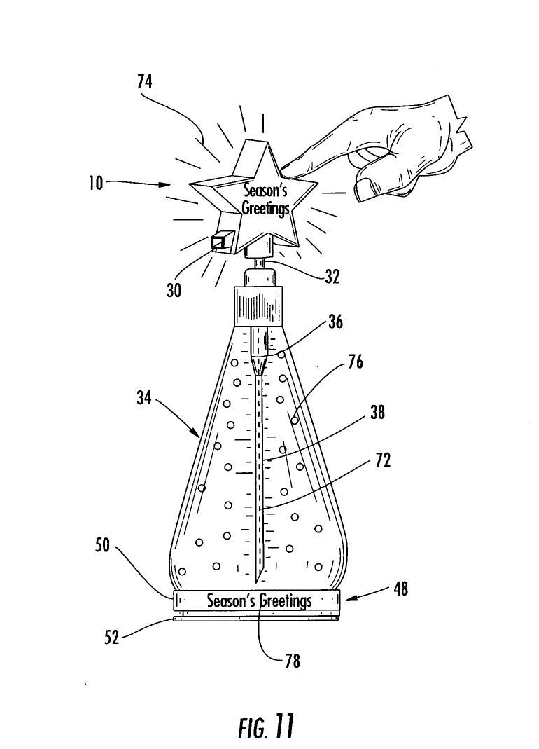

The actuating surface of the topper may be formed during the molding process into any desired ornamental appearance, as illustrated in the non-limiting examples of dispensing assemblies of FIGS. 7-9. As shown in FIG. 5, the topper may include any type of indicia 60 formed thereon, such as alphanumeric characters, pictures, etc. The indicia 60 may be integrally formed during the molding process. For example, as shown in FIG. 5, the PFIZER trademark is formed into the actuating surface during the molding process, thereby providing a permanent and unique advertising medium.

Furthermore, the topper may be constructed and arranged to include tactically readable identifying means specifically targeted for the visually impaired (e.g., blind, low vision). Non-limiting examples of tactically identifying means include, braille, raised line pictures, diagrams, or the like. In this manner, the visually impaired person will be able use the pump toppers of the present invention to readily ascertain the contents of the dispenser container (ketchup, mustard, etc.)

Alternatively, the indicia may be applied after manufacture of the topper by any means of applying known in the art, including, albeit not limited to, paint, adhesive-backed labels, etching, etc.

It is further contemplated herein that the at least one sidewall of the dispensing container may also include indicia 44 attached thereto. Preferably, the indicia on the dispensing container 34 coordinates with the design of the topper 10 for a more pronounced aesthetic or advertising effect, see for example FIGS. 7-9.

Furthermore, the dispenser container may be formed into a three-dimensional design that coordinates with the three-dimensional design of the pump topper to provide an overall theme that is meant to further enhance the appearance of the fluid dispenser assembly. For example, as shown in FIG. 10, the tree-like shaped dispenser body is coordinated with a three-dimensional star-shaped pump topper. The overall result is a unique and decorative holiday theme pump-type dispenser assembly.

For an even more dramatic visual effect, any of the aforementioned embodiments of the dispenser assembly may be used in combination with an illuminating base assembly 48 capable of mounting to the bottom portion 60 of a dispenser container, as shown in FIGS. 10 and 11. The illuminating base assembly is used to illuminate the fluid inside the container, the container itself, and/or it may transmit light along a light-conducting dip tube and actuator 20 to a light-conducting topper attached to the dispensing assembly, as discussed below. The base assembly may be removably, or permanently, attached to the bottom of the container.

FIG. 10 illustrates an exploded view of one non-limiting example of the illuminating base assembly suitable for use with the dispenser assembly. The base assembly of the instant invention comprises a top portion 50 and bottom portion 52 that are constructed and arranged to attach together to define a base interior. The interior contains a plurality of electrical elements 54. The electrical elements include at least one lighting device, preferably, in the form of an LED (light emitting diode) 56 capable of projecting through the top portion of the base through an aperture 58 to introduce light directly from beneath the bottom of the container. The plurality of light sources may have different colors.

The top portion of the base assembly is constructed and arranged to substantially conform to the bottom surface 60 of the container. It is hereby contemplated that the top surface of the base may frictionally engage the outer surface of the bottom of the container; otherwise, the base may include an attachment means capable of allowing the base to removably engage the bottom of the container.

The detachable base assembly allows for enhanced versatility as it may be reused with other dispensing containers. It is preferred that the illuminating base assembly is constructed to readily attach to the bottom of commercially available containers without affecting the manufacture of the container body. Otherwise, the base may be integrally formed or otherwise permanently attached to the bottom of the container by any means known in the art, for instance, adhesives, molding, or the like.

As discussed above and shown in FIG. 10, the lighting device may comprise a plurality of LEDs 56 in electrical communication with other electrical elements, including, for example, at least one power supply 62 (e.g., battery), a sound-emitting means 80, and at least one actuation switch 64, etc., all of which are integrated onto a standard circuit board 66.

The sound-emitting means 80 is constructed and arranged to play pre-recorded sounds, as is well known to the skilled artisan. The sound-emitting means includes a memory 82 capable of storing at least one sound or music score therein. The memory is in electrical communication with at least one audio speaker 84 for projecting the sounds from the dispenser/base assembly. It is particularly preferred, albeit not required, that the sounds emitted coordinate with the overall “theme” of the dispenser/base assembly, such as a holiday or event. For example, the sound-emitting means in the base attached to the holiday theme assembly, shown in FIG. 10, could be made to include and play at least one holiday carol.

The electrical elements may be configured to have various preset control modes which control the operation of the LEDs and sound-emitting means, as is well known in the art. For example, the LEDs may continuously emit light or flash in a pattern for a predetermined time period. Otherwise the base may contain at least one user accessible switch (not shown) that the user may be able to directly manipulate the control modes to obtain different sounds or various light patterns, as desired.

Referring again to FIG. 10, the top portion and bottom portion of the base assembly have at least one biasing means 68 (e.g., helical spring, leaf spring, etc.) positioned therebetween. The top and bottom portion of the base may be attached together by any fastening means known in the art (e.g., corresponding threads), shown here as, albeit not limited to, screws 70 which engage downwardly projecting threaded members 72 formed in the top portion of the base.

The bottom surface of the circuit broad has at least one downwardly projecting “openly biased” actuation switch 64 attached thereto. The actuation switch is in electrical communication with the LEDs, power source, and optionally, a sound emitting means, wherein closure of the switch completes the circuit allowing electricity to flow therebetween. In an alterative embodiment not shown, the switch may be vibration or sound activated, as well known in the art.

During operation of the present embodiment, when the base portions are attached together and disposed on the bottom of the container, downward actuation of the pump topper 10 by the user will compress the biasing means in-between the base portions to force the actuation switch against the bottom portion of the base. This in turn, closes the circuit causing the light sources (LEDs) to become illuminated. In a preferred embodiment, the closure of the circuit will also activate the sound-emitting means 80.

FIG. 11 illustrates the liquid dispenser and base assembly attached together. During the manufacture of the base assembly, the light sources maybe located anywhere on the circuit board to create the desired visual effect when combined with the dispenser assembly. For example, the base assembly may include at least one centrally disposed LED designed to align substantially along the lower end of a light-conducting dip tube 38. Thus, when the user actuates the pump topper, the light emitted 72 from the LED is projected along the length of the dip tube to produce a luminous effect therealong. Examples of light-conducting material include fiber optic material as well as transparent or translucent polymers, which polymers may further contain fluorescers or the like for enhanced effects. As shown in FIG. 10, more LEDs may be located along the periphery of the base to provide illumination of the contents proximate to the outer surface of the container.

Moreover, the actuator 20 and topper 10 may also be construction from a suitable light-conducting material. Thus, when the user actuates the pump topper, as shown in FIG. 11, an LED located below the dip tube will emit light 38 along the dip tube to the integrally connected actuator and topper, which, in turn, emits the light therefrom 74 to produce a spectacular luminous effect.

In one embodiment, the fluid contained in the dispensing container combined with the base assembly is substantially transparent or translucent. It is contemplated herein that the fluid may be lightly tinted or colored, however, the light transmitted therethrough should remain visually perceptible through the container.

Moreover, liquid may be formulated to suspend a plurality of particles 76 therein (FIG. 11), as is widely known in the art. Non-limiting examples of idoneous suspension particles include, bubbles, beads, mica, or the like. These particles may be used to provide additional decorative effect, such as, dye-containing beads or mica which may reflect or refract the light emanating from the LEDs. Additionally, the particles may provide some additional therapeutic effect, such as, moisturizing beads.

In yet another embodiment contemplated herein, the dispensing container used with the base assembly is essentially opaque. Thus, when the user actuates the pump topper, an LED located below the dip tube will emit light 38 along the dip tube to the integrally connected actuator and topper. Since the container body is opaque, any light emitted along the dip tube will not be seen by the user, only the light emitted 74 from the pump topper will be seen. This embodiment provides particular emphasis on the topper itself.

As with the topper and the dispenser container, the base may also include any type of indicia 78 formed thereon (FIG. 11), such as alphanumeric characters, pictures, designs, tactically readable indicia, etc. The indicia may be used to display any message, logo, trademark, etc. In a particularly preferred embodiment, the base indicia coordinates with the container and/or pump topper to provide an overall striking appearance.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A pump actuator topper for use with a conventional pump actuator including an outwardly extending nozzle, said pump actuator topper comprising:
a unitary molded construction including a proximal actuating surface, a distal attachment surface having a plurality of integrally formed attachment means capable of attaching to said pump actuator;
wherein said topper is molded into an ornamental design.

2. The pump actuator topper as set forth in claim 1, wherein said attachment means further includes a receiving bore capable of receiving at least a portion of said pump actuator.

3. A fluid dispenser assembly comprising:
a container body having an upper end, a lower end, at least one sidewall extending therebetween, and an opening formed at said upper end thereof;
a pump actuator secured to said opening, said pump actuator in fluid communication with a dip tube disposed within said container;
a pump actuator topper including a unitary molded construction including a proximal actuating surface, a distal attachment surface having a plurality of integrally formed attachment means capable of attaching to said pump actuator, wherein said topper is molded into an ornamental design.

4. The fluid dispenser assembly as set forth in claim 3, wherein said container body includes at least one indicia thereon.

5. The fluid dispenser assembly as set forth in claim 4, wherein said ornamental design of said topper coordinates with said indicia on said container body.

6. The fluid dispenser assembly as set forth in claim 5, wherein said container body is formed into three-dimensional design.

7. The fluid dispenser assembly as set forth in claim 6, wherein said ornamental design of said topper coordinates with said three-dimensional design of said container body.

8. The fluid dispenser assembly as set forth in claim 6, further comprising an illuminating base assembly constructed and arranged to attach to the bottom surface of said container body, said base having at least one light source contained therein, wherein said at least one light source is directed to project light through the bottom of said container body upon movement of said pump actuator.

9. The fluid dispenser assembly as set forth in claim 8, said illuminating base assembly further comprising a sound emitting means constructed and arranged to play at least one sound or song.

10. The fluid dispenser assembly as set forth in claim 8, wherein said dip tube is constructed from a light-conducting material and said at least one light source is disposed within the base assembly to align below the lower end of said dip tube thereby transmitting light along a substantial portion of said dip tube to provide a luminous decorating effect.

11. The fluid dispenser assembly as set forth in claim 10, wherein said pump actuator and said pump actuator topper are constructed from a light-conducting material and the light transmitted along the entire portion of said dip tube illuminates said pump actuator topper, thereby creating a luminous decorative effect.

12. The fluid dispenser assembly as set forth in claim 7, further comprising an illuminating base assembly constructed and arranged to attach to the bottom surface of said container body, said base having at least one light source contained therein, wherein said at least one light source is directed to project light through the bottom of said container body upon movement of said pump actuator.

13. The fluid dispenser assembly as set forth in claim 12, said illuminating base assembly further comprising a sound emitting means constructed and arranged to play at least one sound or song.

14. The fluid dispenser assembly as set forth in claim 12, wherein said dip tube is constructed from a light-conducting material and said at least one light source is disposed within the base assembly to align below the lower end of said dip tube thereby transmitting light along a substantial portion of said dip tube to provide a luminous decorating effect.

15. The fluid dispenser assembly as set forth in claim 14, wherein said pump actuator and said pump actuator topper are constructed from a light-conducting material and the light transmitted along the entire portion of said dip tube illuminates said pump actuator topper, thereby creating a luminous decorative effect.

16. The fluid dispenser assembly as set forth in claim 3, further comprising an illuminating base assembly constructed and arranged to attach to the bottom surface of said container body, said base having at least one light source contained therein, wherein said at least one light source is directed to project light through the bottom of said container body upon movement of said pump actuator.

17. The fluid dispenser assembly as set forth in claim 16, said illuminating base assembly further comprising a sound emitting means constructed and arranged to play at least one sound or song.

18. The fluid dispenser assembly as set forth in claim 16, wherein said dip tube is constructed from a light-conducting material and said at least one light source is disposed within the base assembly to align below the lower end of said dip tube thereby transmitting light along a substantial portion of said dip tube to provide a luminous decorating effect.

19. The fluid dispenser assembly as set forth in claim 18, wherein said pump actuator and said pump actuator topper are constructed from a light-conducting material and the light transmitted along the entire portion of said dip tube illuminates said pump actuator topper, thereby creating a luminous decorative effect.
